(19) United States
(12) Patent Application Publication
(10) Pub. No.: US 2015/0349975 A1
(43) Pub. Date: Dec. 3, 2015

(54) Home gateway and smart terminal integrated system and communication method thereof

(71) Applicant: ZTE Corporation, Shenzhen, Guangdong (CN)

(72) Inventors: Li Hu, Shenzhen (CN); Huan Lu, Shenzhen (CN); Xinghua Li, Shenzhen (CN)

(21) Appl. No.: 14/436,611

(22) PCT Filed: Jul. 16, 2013
(86) PCT No.: PCT/CN2013/079475

§ 371 Date: Apr. 17, 2015

(30) Foreign Application Priority Data
Oct. 19, 2012 (CN) 201210401199.X

(51) Int. Cl. H04L 12/28; H04L 29/08; G06F 9/455; H04L 12/66

(52) U.S. Cl. CPC H04L 12/2834; H04L 12/282; H04L 12/66; H04L 67/12; G06F 9/45558; H04L 2012/2841; G06F 2009/45595

(57) ABSTRACT

A home gateway and smart terminal integrated system is described, which includes a home gateway body and at least one subsidiary smart terminal. The home gateway body adopts a multi-core processor architecture and virtualization technology, and has abundant software and hardware resources, and can conduct function extension in a manner of installing application software in addition to having a routing and forwarding function of an existing home gateway; and the subsidiary smart terminal enables a user to securely operate an smart household terminal only by the software and hardware resources. Thus the problem that the utilization rate of a smart terminal device is low and functions of an existing home gateway are single, and etc. is solved without purchasing a smart terminal for each family member.

### TECHNICAL FIELD

The disclosure relates to a control technology of the Internet of Things, and more particularly to a home gateway and smart terminal integrated system and a communication method thereof.

### BACKGROUND

Statistical data of 3^{rd} Generation (3G) operators have shown that almost 80% of 3G communication services used by users occur in an indoor environment. The so-called indoor environment may be considered as a “static” state or a “non-mobile” state. Generally, a user who needs to concentrate on something is frequently in a “static” state, which means that most 3G communication traffic will occur indoors. Home is an indoor environment in which most service communication is performed by users, and communication services occurring in home mainly lie in two aspects, life and entertainment. A user may browse webpage, view online video, shop online play games, and etc. through service communication between a smart terminal device and a home network or an external network.

With constant improvement of smart terminal technologies, users prefer to use smart terminal devices, such as smart phones and tablet computers and etc. to perform service communication, which gradually weakens the dominance of household Personal Computers (PC). However, PC is still required when a home service, such as a large scale Three Dimensions (3D) game and playing of a high-definition video, needs to occupy more computing and storage resources.

Since family members of different ages require different services, smart terminal devices may be insufficient in the case that there are a small number of smart terminal devices or household PCs. It will increase the economic burden to purchase a tablet computer or a PC for each family member, and in addition, most home services do not need to occupy many software and hardware resources during operation, and one tablet computer or PC is enough. Therefore, purchasing a tablet computer or PC for each family member will reduce the utilization rate of device resources and cause resource waste.

Service communication between a smart terminal device and a home network or an external network mainly refers to data exchange between a smart terminal device and a home gateway which is a core device in the home network to realize connection among all smart terminal devices inside a home on one hand, e.g. transmitting a fantastic movie in a tablet computer or a PC to a television to watch, and on the other hand, to realize connection of a smart terminal device inside the home or an internal network with an external network. Since most home gateway devices on the market are only provided with a routing and forwarding function at present, which not only results in a single function, but also fails to provide an extension function. In addition, it is impractical to purchase a tablet computer or a PC for each family member. Therefore, a home gateway and smart terminal integrated solution is needed urgently.

### SUMMARY

In view of this, the main purpose of the embodiments of the disclosure is to provide a home gateway and smart terminal integrated system and a communication method thereof to solve the problems in the prior art that the utilization rate of device resources is low, functions of a home gateway are single and function extension cannot be provided.

To realize the purpose above, the technical solution of the embodiments of the disclosure is realized by the following way.

An embodiment of the disclosure provides a home gateway and smart terminal integrated system, the system includes a home gateway body and at least one subsidiary smart terminal, wherein

the subsidiary smart terminal includes a terminal hardware layer and a terminal software layer and is configured to display a user graphic interface and support a user input operation; and

the home gateway body includes a hardware layer and a software layer and is configured to perform software and hardware resource processing on the user graphic interface and the user input operation, and to send a processing result to the subsidiary smart terminal or an external network, or to receive data from outside and make a response.

In the solution, the hardware layer may include a multi-core processor, a Random Access Memory (RAM), a solid state driver, a Universal Serial Bus (USB) host, an Ethernet switch module, a Wireless Fidelity (WiFi) access module, and an external network interface module.

In the solution, the software layer may include a Virtual Machine Monitor (VMM) module, a Virtual Machine (VM) and a home gateway software module, wherein

the VMM module is configured to establish at least one said VM, and distribute and schedule a hardware resource for the VM;

the VM includes a subsidiary smart terminal operating system and applications; the subsidiary smart terminal operating system is configured to draw the user graphic interface and respond to the user input operation, and is further configured to complete data communication outside; and

the home gateway software module is configured to operate a built-in software function of an existing home gateway.

In the solution, the VMM module may include a switcher software module, a first driver proxy, an Ethernet driver, a WiFi driver, and an external network driver, wherein

the switcher software module is configured to inquire for a Media Access Control (MAC) address, and write, according to the MAC address, data into a driver queue;

the Ethernet driver is provided with an Ethernet driver queue, and is configured to drive, when the integrated system performs wired communication with a home network, the integrated system to write data into the Ethernet driver queue;

the WiFi driver is provided with a WiFi driver queue and is configured to drive, when the integrated system performs wireless communication with a home network, the integrated system to write data into the WiFi driver queue; and

the external network driver is provided with an external network driver queue and is configured to drive, when the integrated system performs data communication with a WAN, the integrated system to write data into the external network driver queue.

In the solution, the terminal software layer may include a second driver proxy.

In the solution, the first driver proxy may include a Gateway Display Driver Proxy (GDDP) and an input driver proxy; the second driver proxy includes a terminal display driver proxy and a touch driver proxy, wherein

the GDDP and the terminal display driver proxy are configured to display the user graphic interface, and establish a link during initialization of the integrated system;

the input driver proxy and the touch driver proxy are configured to support the user input operation, and establish a link during initialization of the integrated system.

In the solution, the GDDP may be further configured to store data.

Another embodiment of the disclosure further provides a communication method for a home gateway and smart terminal integrated system, wherein the method includes that

a subsidiary smart terminal displays a user graphic interface and supports a user input operation;

a home gateway body encapsulates data corresponding to the user graphic interface and the user input operation to form a data frame, and then sends, according to an MAC address, the data frame to a subsidiary smart terminal which is connected to a home network, or to an external network, or receives data from an external network and makes a response.

In the solution, the communication method may include data communication between an operating system of the subsidiary smart terminal and the home network, data communication between the operating system of the subsidiary smart terminal and the external network, and data communication between operating systems of subsidiary smart terminals, wherein

when the data communication is performed between the operating system of the subsidiary smart terminal and the home network, a driver module first encapsulates data to form a data frame, a VMM module then captures the data frame and delivers the data frame to a switcher software module; the switcher software module performs data transmission according to a target MAC address;

when the data communication is performed between the operating system of the subsidiary smart terminal and the external network, a driver module first encapsulates data to form a data frame, the VMM module then captures the data frame and delivers the data frame to the switcher software module; after the data frame is sent to a home gateway software module to process, the switcher software module performs data transmission according to a target MAC address;

when the data communication is performed between the operating systems of the subsidiary smart terminals, after the driver module encapsulates data to form a data frame, the switcher software module forwards the data frame directly.

In the solution, the driver module may include an Ethernet driver, a WiFi driver, an external network driver and a network driver module.

According to the home gateway and smart terminal integrated system and the communication method thereof provided by the embodiments of the disclosure, the home gateway body therein adopts a multi-core processor architecture and virtualization technology, and has abundant software and hardware resources, in addition to having a routing and forwarding function of an existing home gateway. The subsidiary smart terminal included in the system can implement secure operation on a smart household terminal only using the software and hardware resources of the home gateway body. Without purchasing a smart terminal for each family member, the embodiments of the disclosure can solve the problems in the prior art that the resource utilization rate of a smart terminal device is low, functions of an existing home gateway are single and function extension cannot be provided.

### BRIEF DESCRIPTION OF THE DRAWINGS

FIG. 1 is a structural diagram illustrating components of a home gateway and smart terminal integrated system according to an embodiment of the disclosure;

FIG. 2 is a flowchart of a method for a home gateway and smart terminal integrated system to communicate with external data according to an embodiment of the disclosure;

FIG. 3 is a schematic diagram illustrating an implementation principle for a home gateway and smart terminal integrated system to display a user graphic interface to a subsidiary smart terminal according to an embodiment of the disclosure;

FIG. 4 is a schematic diagram illustrating an implementation principle for a home gateway and smart terminal integrated system to respond to an input operation of a subsidiary smart terminal according to an embodiment of the disclosure;

FIG. 5-1 is a schematic diagram illustrating a process of a home gateway and smart terminal integrated system communicating with a home network and a WAN according to an embodiment of the disclosure; and

FIG. 5-2 is a schematic diagram illustrating a principle for implementing communication data forwarding by a driver queue according to an embodiment of the disclosure.

### DETAILED DESCRIPTION

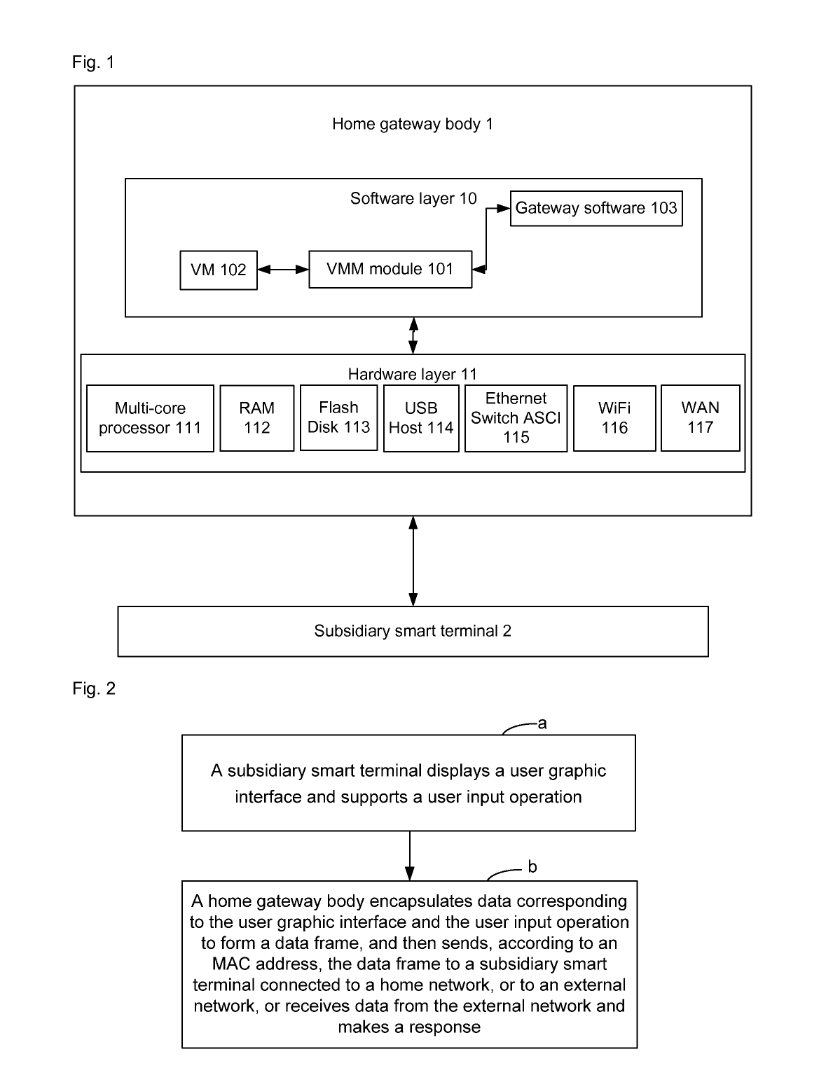

A home gateway and smart terminal integrated system provided by an embodiment of the disclosure, as shown in FIG. 1, includes a home gateway body 1 and at least one subsidiary smart terminals 2, wherein

the subsidiary smart terminal 2 is configured to display a user graphic interface and support a user input operation;

correspondingly, the home gateway body 1 performs software and hardware resource processing on the user graphic interface and the user input operation, and sends a processing result to the subsidiary smart terminal 2 or an external network, or receives data outside itself and makes a response.

Here, the number of subsidiary smart terminals 2 may be N and N is a positive integer.

The subsidiary smart terminal 2 includes a terminal hardware layer and a terminal software layer, wherein the terminal software layer includes a second driver proxy, and a network driver. The terminal hardware layer includes a wireless network/Ethernet chip (WiFi/Ethernet hardware) and a touch screen chip (touch screen hardware), wherein the second driver proxy includes a terminal display driver proxy and a touch driver proxy.

The subsidiary smart terminal 2 may be also embedded in other household smart terminals having a display and input function through software installation so as to utilize software and hardware resources of other household smart terminals to display the user graphic interface and complete the user input operation.

The home gateway body 1 includes a hardware layer 11 and a software layer 10. Preferably, the software layer 10 includes a Virtual Machine Monitor (VMM) module 101, a Virtual Machine (VM) module 102, and a home gateway software module 103; the hardware layer 11 includes a multi-core processor 111, a random access memory (RAM) 112, a solid state disk (e.g. flash disk) 113, a Universal Serial Bus (USB) host 114, an Ethernet switch module (e.g. Ethernet switch ASCI) 115, a wireless network access module (Wireless Fidelity, WiFi) 116, and an external network (e.g. Wide Area Network, WAN) interface module 117.

The hardware layer 11 of the home gateway body 1 adopts a multi-core processor architecture, and the software layer 10 operating on the hardware layer 11 adopts the VMM module 101 in virtualization technology. The VMM module 101 includes a switcher software module, a first driver proxy, an Ethernet driver, a WiFi driver, and an external network driver (e.g. WAN Driver).

The VMM module 101 is configured to establish at least one VM 102, and distribute and schedule a hardware resource for the VM 102.

The VM 102 includes a subsidiary smart terminal operating system (hereinafter referred to as operating system for short) and an application layer (Applications); the operating system is configured to draw the user graphic interface and respond to the user input operation, and is further configured to complete data communication outside itself. Specifically, the operating system is connected with the switcher software module to complete data communication between the operating systems, between the operating system and a home network, and between external networks.

The home gateway software module 103 is configured to operate a built-in software function of an existing home gateway, wherein the operating system includes a display driver module, a touch driver module and a network driver module.

The first driver proxy includes a Gateway Display Driver Proxy (GDDP) and an input driver proxy, wherein the network driver module is provided with a network driver module queue and is configured to drive, when the operating system communicates with data outside itself, the operating system to write the data into the network driver module queue; the Ethernet driver is provided with an Ethernet driver queue, and is configured to drive, when the integrated system performs wired communication with a home network, the integrated system to write data into the Ethernet driver queue; the WiFi driver is provided with a WiFi driver queue and is configured to drive, when the integrated system performs wireless communication with the home network, the integrated system to write data into the WiFi driver queue; the WAN driver is provided with a WAN driver queue and is configured to drive, when the integrated system performs data communication with an external network, the integrated system to write data into the external network driver queue.

The operating system may be Android or Linux, and etc.

The VMM module 101 applies a microkernel technology to provide the operating system with basic kernel functions including address space management, thread scheduling and communication among processes etc. and set a function of the first driver proxy in a user mode to prevent unavailability of the integrated system caused by an unreasonable layout.

Alternatively, the home gateway software module 103 may operate in the VMM module 101 and may also operate in the VM 102. The home gateway software module 103 is provided with core communication functions including routing and forwarding and etc., which may be completed by binding at least one kernel in the multi-core processor.

The operating system and the subsidiary smart terminal 2 are connected in a wired or wireless way, wherein the wireless way includes the WiFi 116 and the wire way includes an Ethernet interface, a Passive Optical Network (PON) and a Digital Subscriber Line (DSL).

When a user touches the subsidiary smart terminal 2, the subsidiary smart terminal 2 acquires a touch action, and delivers, through the WiFi 116 or the Ethernet interface, the touch to the Ethernet switcher ASCI 115. The VMM module 101 controls the Ethernet switcher ASCI 115 to send the touch to the VM 102. The operating system in the VM 102 reads the touch and makes a response.

When the subsidiary smart terminal 2 is configured to display the user graphic interface of the operating system, the VMM module 101 acquires an input control operation on the operating system, processes frame data of the input control operation to form frame cache data and store the frame cache data in the display driver module, and transmits, through a connection established between the GDDP and the terminal display driver proxy, the frame cache data to the subsidiary smart terminal 2. The subsidiary smart terminal 2 receives and responds to the frame cache data which then form the user graphic interface, and displays the user graphic interface to a user, wherein the GDDP may accelerate a reading operation of the frame cache data by storing the frame cache data.

Based on the home gateway and smart terminal integrated system, an embodiment of the disclosure further provides a communication method for a home gateway and smart terminal integrated system. As shown in FIG. 2, the method includes:

Step a: a subsidiary smart terminal displays a user graphic interface and supports a user input operation; and

Step b: a home gateway body encapsulates data corresponding to the user graphic interface and the user input operation to form a data frame, and then sends, according to an MAC address, the data frame to a subsidiary smart terminal connected to a home network, or to an external network, or receives data from an external network and makes a response.

Here, data communication between the integrated system and the exterior mainly refers to data communication between the operating system and a home network or an external network.

Preferably, when the data communication is performed between the operating system and the home network, their respective driver modules first encapsulate data to form a data frame, a VMM module 101 then captures the data frame and delivers the data frame to a switcher software module; the switcher software module performs data transmission according to a target MAC address.

When the data communication is performed between the operating system and an external network, their respective driver modules first encapsulate data to form a data frame, a VMM module 101 then captures the data frame and delivers the data frame to the switcher software module; after sending the data frame to the home gateway software module 103 to process, the switcher software module performs data transmission according to a target MAC address; wherein the driver module includes a network driver module of the operating system, an Ethernet driver, a WiFi driver and a WAN driver;

Specifically, data sent by the operating system to the home network is first encapsulated by the network driver module to form a data frame which is then captured by the VMM module 101 and delivered to the switcher software module. After the switcher software module writes the data frame into the Ethernet driver queue or the WiFi driver queue according to a target MAC address, the switcher software module forwards the data frame according to the MAC address.

The data sent by the home network to the operating system is first encapsulated by the Ethernet driver or the WiFi driver to form a data frame which is then captured by the VMM module 101 and delivered to the switcher software module. After the switcher software module writes, according to a target MAC address, the data frame into the network driver module queue corresponding to the network driver module of the operating system, the switcher software module subsequently transmits the data frame to the applications to execute a response of the data frame.

Data sent by the operating system to the WAN is first encapsulated by the network driver module to form a data frame which is then captured by the VMM module 101 and delivered to the switcher software module. The switcher software module sends the data frame to the home gateway software module 103 to process, and then the switcher software module writes, according to a target MAC, the data frame into the WAN driver queue, and finally sends, according to the MAC address, the data frame to the WAN.

Data sent by the WAN to the operating system is first encapsulated by the WAN driver to form a data frame which is then captured by the VMM module 101 and delivered to the switcher software module. The switcher software module sends the data frame to the home gateway software module 103 to process, and then the switcher software module writes, according to a target MAC, the data frame into the network driver module queue. The operating system reads the data frame and makes a response. The applications execute the response.

Data among the operating systems is encapsulated by the network driver module to form a data frame which is then forwarded directly by the switcher software module.

In the embodiments as shown in FIG. 3 to FIG. 5-2, the operating system is an Android system and the home gateway software module 103 operates in the VMM module 101.

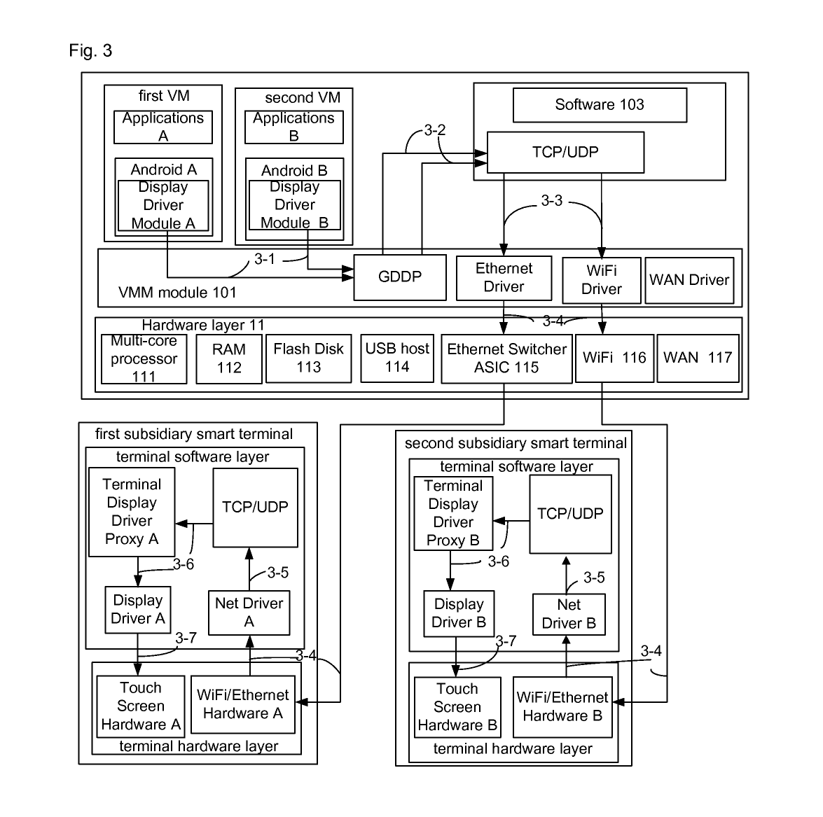

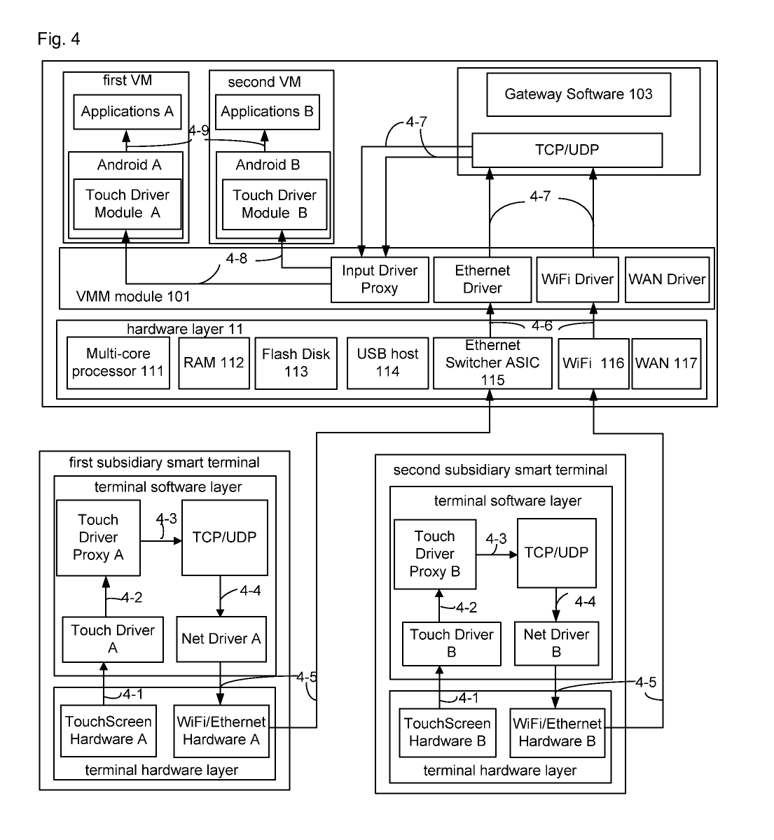

In the embodiments as shown in FIG. 3 and FIG. 4, the home gateway software module 103 may apply Transmission Control Protocol (TCP)/a User Datagram Protocol (UDP). The VMM module 101 creates two said VMs 102, a first VM and a second VM. The first VM operates in Android A system which corresponds to applications A, while the second VM operates in Android B system which corresponds to applications B. Corresponding to the first VM and the second VM, the subsidiary smart terminal 2 includes a first subsidiary smart terminal and a second subsidiary smart terminal. The first subsidiary smart terminal includes a first terminal software layer and a first terminal hardware layer. The second subsidiary smart terminal includes a second terminal software layer and a second terminal hardware layer. The first terminal hardware layer includes WiFi/Ethernet hardware A and touch screen hardware A. The second terminal hardware layer includes WiFi/Ethernet hardware B and touch screen hardware B.

FIG. 3 is a schematic diagram illustrating an implementation principle for a home gateway and smart terminal integrated system to display a user graphic interface to a subsidiary smart terminal according to an embodiment of the disclosure.

In the present embodiment, the Android A system includes display driver module A. The Android B system includes display driver module B. The first driver proxy includes a GDDP. The second driver proxy includes a terminal display proxy. The first terminal software layer includes network driver A, TCP/UDP, terminal display driver proxy A and terminal display driver A. The second terminal software layer includes network driver B, TCP/UDP, terminal display driver proxy B and terminal display driver B.

Specifically, the Android A system in the first VM displays, through an Ethernet interface, the user graphic interface to the first subsidiary smart terminal. The Android B system in the second VM displays, through the WiFi 116, the user graphic interface to the second subsidiary smart terminal. A process of displaying the user graphic interface to a user is as follows:

Step (3-1): the Android A system performs frame data caching on an input control operation by using the display driver module A, to form frame cache data A;

the Android B system performs frame data caching on an input control operation by using the display driver module B, to form frame cache data B;

the VMM module 101 captures the frame cache data A and the frame cache data B and transmits the data A and B to the GDDP;

Step (3-2): the GDDP sends the frame cache data A and the frame cache data B to a TCP/UDP process, wherein the TCP/UDP process is established by the GDDP, the terminal display driver proxy A and the terminal display driver proxy B during respective initialization of the Android A system and the Android B system;

Step (3-3): the TCP/UDP process transmits the frame cache data A to the Ethernet driver and the frame cache data B to the WiFi driver;

Step (3-4): the Ethernet driver transmits the frame cache data A to the Ethernet switcher ASCI 115; the Ethernet switcher ASCI 115 sends, through an Ethernet interface/network cable, the frame cache data A to the WiFi/Ethernet hardware A on the first subsidiary smart terminal, and the frame cache data A is sent by the Ethernet hardware 1 to the network driver A;

the WiFi driver transmits the frame cache data B to the WiFi 116; the WiFi 116 sends, through a wireless network, the frame cache data B to the WiFi/Ethernet hardware B of the second subsidiary smart terminal, and the frame cache data B is sent by the WiFi/Ethernet hardware B to the network driver B;

Step (3-5): the network driver A and the network driver B distribute the frame cache data A and the frame cache data B to the respective TCP/UDP processes of the first subsidiary smart terminal and the second subsidiary smart terminal;

Step (3-6): the TCP/UDP process of the first subsidiary smart terminal sends the frame cache data A to the terminal display drive proxy A; the terminal display drive proxy A transmits the frame cache data A to the display driver A;

the TCP/UDP process of the second subsidiary smart terminal sends the frame cache data B to the terminal display drive proxy B; the terminal display drive proxy B transmits the frame cache data B to the display driver B;

Step (3-7): the display driver A writes the frame cache data A into the touch screen hardware A, the display of the first subsidiary terminal makes a response, and forms and displays a user graphic interface A to the user;

the display driver B writes the frame cache data B into the touch screen hardware B, the display of the second subsidiary smart terminal makes a response and forms and displays a user graphic interface A to the user.

Here, the GDDP is further configured to store the frame cache data A and the frame cache data B to reduce the cost for the integrated system in data reading.

A process of reading, by the operating system, display screen parameters of the second subsidiary smart terminal 2 is the same as the process of the embodiments above. In addition, after reading the display screen parameters of the subsidiary smart terminal 2 for the first time, the operating system may store the display screen parameters into the GDDP. In this way, the cost in reading the display screen parameters from the subsidiary smart terminal 2 may be reduced, and reading of the parameters may be accelerated. The display screen parameters include the resolution of the display screen, and the number of bits of each pixel of the display screen.

FIG. 4 is a schematic diagram illustrating an implementation principle for a home gateway and smart terminal integrated system to respond to an input operation of a subsidiary smart terminal according to an embodiment of the disclosure. In the present embodiment, the Android A system includes a touch driver module A. The Android B system includes a touch drive module B. The first driver proxy includes an input driver proxy. The second driver proxy includes a touch driver proxy. The first terminal software layer includes network driver A, TCP/UDP, touch driver proxy A and touch driver A. The second terminal software layer includes network driver B, TCP/UDP, touch driver proxy B and touch driver B.

Specifically, the first VM responds, through the Ethernet interface, to an input operation of the first subsidiary smart terminal; the second VM responds, through the WiFi 116, to an input operation of the second subsidiary smart terminal. A specific response process is as follows:

Step (4-1): the touch screen hardware A acquires a user input touch A and reports, through a hardware interruption mode, touch information A to the touch driver A;

the touch screen hardware B acquires a user input touch B and reports, through a hardware interruption mode, touch information B to the touch driver B;

wherein the touch information includes a location on the subsidiary smart terminal 2, where the touch occurs, a touch type, and a pressure received when the subsidiary smart terminal 2 is touched;

Step (4-2): the touch driver A and the touch driver B send the touch information A and the touch information B to the touch driver proxy A and the touch driver proxy B;

Step (4-3): the touch driver A and the touch driver B send the touch A and the touch B to the TCP/UDP process, wherein the TCP/UDP process is established by the input driver proxy, the touch driver proxy A and the touch driver proxy B during respective self-initialization of the Android A system and the Android B system;

Step (4-4): the TCP/UDP processes send the touch information A and the touch information B respectively to the network driver A and the network driver B;

Step (4-5): the network driver A and the network driver B transmit the touch information A and the touch information B to the WiFi/Ethernet hardware A and the WiFi/Ethernet hardware B;

the WiFi/Ethernet hardware A transmits, through the Ethernet interface/network cable, the touch information A to the Ethernet switch ASCI 115;

the WiFi/Ethernet hardware B transmits, through the wireless network, the touch information B to the WiFi 116;

Step (4-6): the Ethernet switcher ASCI 115 forwards the touch information A to the Ethernet driver;

the WiFi 116 forwards the touch information B to the WiFi driver;

Step (4-7): the Ethernet driver and the WiFi driver deliver, through the TCP/UDP processes, the touch information A and the touch information B to the input driver proxy;

Step (4-8): the VMM module 101 controls the input driver proxy to send the touch information A and the touch information B to the touch module A in the Android A system and the touch module B in the Android B system; and

Step (4-9): the Android A system reads and responds to the touch information A, and the applications A executes a response action A according to the response;

the android B system reads and responds to the touch information B, and the applications B executes a response action B according to the response.

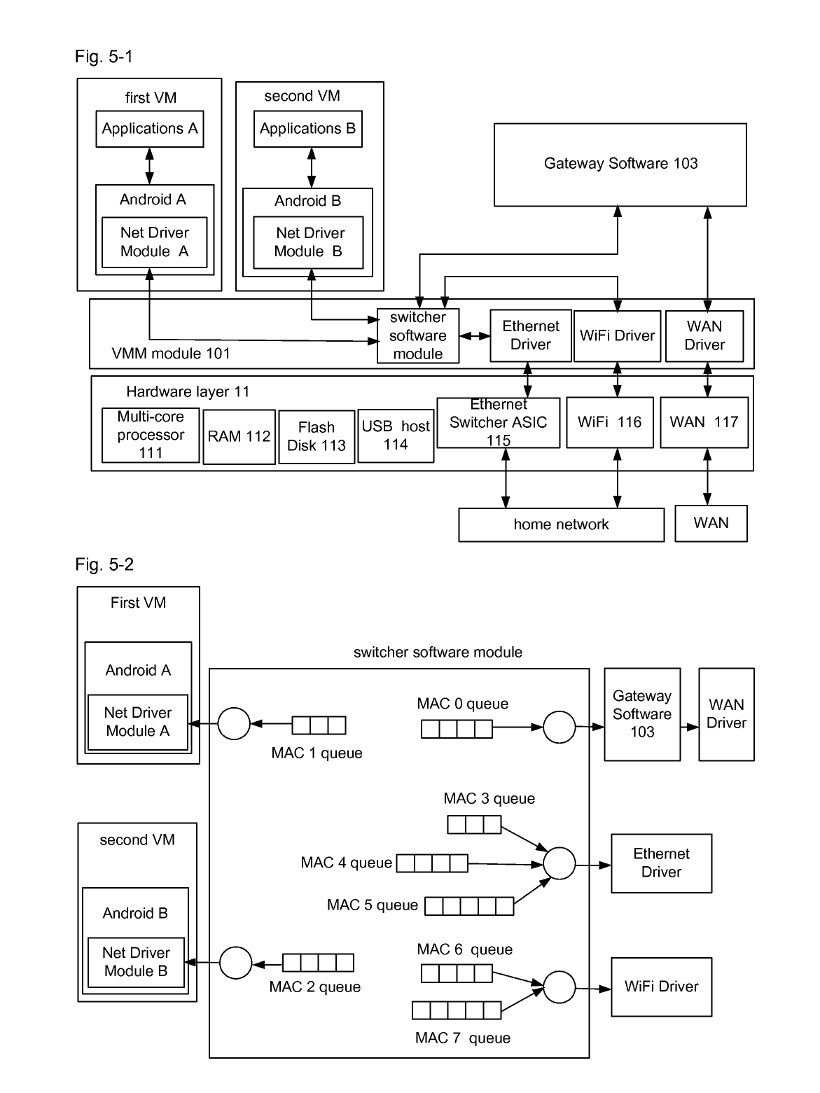

FIG. 5-1 is a schematic diagram illustrating a process of a home gateway and smart terminal integrated system communicating with a home network and an external network according to an embodiment of the disclosure.

In the embodiments as shown in FIG. 5-1 and FIG. 5-2, the VMM module 101 creates two said VMs 102, a first VM and a second VM. The first VM operates in Android A system which corresponds to applications A, while the second VM operates in Android B system which corresponds to applications B. The Android A system includes a network driver module A and the Android B system includes a network driver module B. The VMM module 101 includes a switcher software module, an Ethernet driver, a WiFi driver, and a WAN driver, wherein the Android A system communicates with a home network, and the Android B system communicates with a WAN.

Data sent by the Android A system to the Android B system is first encapsulated by the network driver module A of the Android A system to form a data frame. The VMM module 101 captures the data frame and delivers the data frame to the switcher software module. The switcher software module writes, according to a target MAC address, the data frame into a network driver module queue B corresponding to the network driver module B of the Android B system. The Android B system reads and responds to the data frame and the applications B executes the response.

Data sent by the Android B system to the Android A system is first encapsulated by the network driver module B of the Android B system to form a data frame. The VMM module 101 captures the data frame and delivers the data frame to the switcher software module. The switcher software module writes, according to a target MAC address, the data frame into a network driver module queue A corresponding to the network driver module A of the Android A system. The Android A system reads and responds to the data frame and the applications A executes the response.

Data sent by the Android A system to the home network is first encapsulated by the network driver module A to form a data frame. The VMM module 101 captures the data frame and delivers the data frame to the switcher software module. The switcher software module writes, according to a target MAC address, the data frame into an Ethernet driver queue or a WiFi driver queue, and the data frame is finally sent to the home network through the Ethernet switcher ASCI 115 or the WiFi 116.

Data sent by the android B system to the WAN is first encapsulated by the network driver module B to form a data frame. The VMM module 101 captures the data frame and delivers the data frame to the switcher software module. The switcher software module will first send the data frame to the home gateway software module 103 to perform processing including Network Address Translation (NAT), Internet Protocol Security (IPSec) and etc., and then writes, according to a target MAC address, the data frame into a WAN driver queue, and the data frame is finally sent by the WAN 117 to the WAN.

Data sent by the home network to the Android A system arrives the Ethernet driver or the WiFi driver through the Ethernet switch ASCI 115 or the WiFi 116. The Ethernet driver or the WiFi driver encapsulates the data to form a data frame. The VMM module 101 captures the data frame and delivers the data frame to the switcher software module. The switcher software module writes, according to a target MAC address, the data frame into the network driver module queue A. The Android A system reads and responds to the data frame. The applications A executes the response.

Data sent by the WAN arrives at the WAN driver through the WAN 117. The WAN driver encapsulates the data into a data frame. The WAN driver transmits the data frame to the home gateway software module 103 and performs processing including NAT and IPSec and etc. After capturing the processed data frame, the VMM module 101 sends the processed data frame to the switch module. The switch module writes, according to a target MAC address, the data frame into the network driver module B. The Android B system reads and responds to the data frame. The applications B executes the response operation.

In the embodiments above, communication data is mainly written into the Ethernet driver queue, the WiFi driver queue, and the WAN driver queue and forwarded. A specific forwarding process is as shown in FIG. 5-2. In the present embodiment, the MAC address of a Central Processing Unit (CPU) port of the multi-core processor is MAC 0. The MAC address of the Android A system is MAC 1, then the MAC address of a frame output queue associated with the network driver module A is MAC 1. The MAC address of the Android B system is MAC 2, then the MAC address of a frame output queue associated with the network driver module B is MAC 2, the MAC addresses of three frame output queues associated with the Ethernet driver are MAC 3, MAC 4 and MAC 5, respectively. The MAC addresses corresponding to two frame output queues associated with the WiFi driver are MAC 6 and MAC 7, respectively.

Situation 1 is that data communication is performed between the operating systems of different VMs 102;

when the Android A system of the first VM receives data sent by the applications A, the network driver module A performs data encapsulation, forms an MAC 1 data frame and sends out the MAC 1 data frame to a target address MAC 2; the VMM module 101 captures the MAC 1 data frame and sends the MAC 1 data frame to the switcher software module; the switcher software module performs target address inquiry for the MAC 2 address, and then adds the MAC 1 data frame to a frame output queue whose target address is MAC 2, i.e. the network driver module queue B, then sends the MAC 1 data frame to the network driver module B of the Android B system. The Android B system reads and responds to the MAC A data frame and the applications B executes the response operation;

Situation 2 is that data communication is performed between the operating system and the home network;

the Android A system establishes a connection with the home network through the wired way, uses the network driver module A to encapsulate data sent by the applications A into an MAC 1 data frame and sends out the MAC 1 data frame to a target address MAC 5; the VMM module 101 captures the MAC 1 data frame and sends the MAC 1 data frame to the switcher software module; the switcher software module performs target address inquiry for the MAC 5 address, and then adds the MAC 1 data frame to a frame output queue whose target address is MAC 5, i.e. the Ethernet driver queue which is associated with the Ethernet driver and whose address is MAC 5, and then sends the MAC 1 data frame to the Ethernet driver. The Ethernet driver sends the MAC 1 data frame whose target address is MAC 5 to the Ethernet switch ASCI 115. The Ethernet switch ASCI 115 sends, through the Ethernet interface/network cable, the MAC 1 data frame to a device having the MAC 5 address and connected to the home network;

the Android A system establishes a connection with the home network through the wireless way, uses the network driver module A to encapsulate data sent by the applications A into an MAC 1 data frame and sends out the MAC 1 data frame to a target address MAC 7; the VMM module 101 captures the MAC 1 data frame and sends the MAC 1 data frame to the switcher software module; the switcher software module performs target address inquiry for the MAC 7 address, and then adds the MAC 1 data frame to a frame output queue whose target address is MAC 7, i.e. the WiFi driver queue which is associated with the WiFi driver and whose address is MAC 7, and then sends the MAC 1 data frame to the WiFi driver. The WiFi driver sends the MAC 1 data frame whose target address is MAC 7 to the WiFi 116. The WiFi 116 sends, through the wireless way, the MAC 1 data frame to a device having the MAC 7 address and connected to the home network;

Situation 3 is that data communication is performed between the operating system and the WAN;

the Android B system receives data sent by the applications B, uses the network driver module B to encapsulate the data to form an MAC 2 data frame and sends out the MAC 2 data frame to a target address MAC 0; the VMM module 101 captures the MAC 2 data frame and sends the MAC 2 data frame to the switcher software module; the switcher software module performs target address inquiry for the MAC 0 address, and then adds the MAC 2 data frame to a frame output queue whose target address is MAC 0, i.e. the CPU output queue of the multi-core processor, then sends the MAC 2 data frame to an built-in software module 103 of an existing home gateway, and performs processing including NAT and IPsec; driven by the WAN driver, the multi-core processor sends, through the WAN 117, the MAC 2 data frame to the WAN;

Situation 4 is that data communication is performed between devices in the home network;

when two parties involved in communication are devices connected in the home network, data exchange may be performed directly through the Ethernet switch ASCI 115;

when the device 3 connected to an home internal wire network performs data communication with the device 4 connected to the home internal wire network, data generated by the device 3 is transmitted, through the Ethernet switch ASCI 115, to the Ethernet driver; the Ethernet driver encapsulates the data into a frame to form a data frame of a device 3 with a target address of MAC 7; the Ethernet driver sends the data frame of the device 3 to the switcher software module; the switcher software module performs target address inquiry, and then adds the data frame of the device 3 to a frame output queue with a target address of MAC 7, i.e. the WiFi driver queue, and then sends the data frame of the device 3 to the WiFi driver; the WiFi driver sends to the WiFi 116 the data frame of the device 3 with a target address of MAC 7; the WiFi 116 sends the data frame of the device 3 to the device 4 having a address of MAC 7 in the wireless way;

Situation 5 is that data communication is performed between a device in the home network and a WAN;

the device 3/device 4 connected to a home internal wired/wireless network needs to perform data communication with the device 5 connected to the WAN; data generated by the device 3/device 4 is transmitted, through the Ethernet switch ASCI 115/WiFi 116, to the Ethernet/WiFi driver; the Ethernet/WiFi driver encapsulates the data into a frame to form a data frame of the device 3/a data frame of the device 4 with a target address of MAC 0; the Ethernet/WiFi driver sends the data frame of the device 3/the data frame of the device 4 to the switcher software module; the switcher software module performs target address inquiry, and then adds the data frame of the device 3/the data frame of the device 4 to a frame output queue with a target address of MAC 0, i.e. the CPU output queue of the multi-core processor, and then sends the data frame of the data frame of the device 3/the data frame of the device 4 to the home gateway software module 103 and performs processing including NAT and IPsec; driven by the WAN driver, the multi-core processor sends, through the WAN 117, the data frame of the device 3/the data frame of the device 4 to the device 5.

When implementing the embodiments above, the data communication is all unidirectional transmission which may be considered as forward transmission. Substantially, the embodiments of the disclosure may provide bi-directional transmission for the data communication, and an inverse transmission process is opposite to a forward transmission process.

In a home gateway and smart terminal integrated system provided by the embodiments of the disclosure, a home gateway body adopts a multi-core processor architecture and virtualization technology, and has abundant software and hardware resources in addition to having a routing and forwarding function and etc. of an existing home gateway. A subsidiary smart terminal included in the integrated system can use the software and hardware resources of the home gateway body and a home network to complete rapid communication of the Internet of Things, wherein different subsidiary smart terminals may be operated by different VMs, thus enhancing security isolation. The VM applies a user graphic interface, which facilitates operations for a smart household terminal. Various kinds of application software may be installed in an operating system included in the VM to realize function extension of the home gateway body.

What are described above are only embodiments of the disclosure, and are not used for limiting the disclosure. Those skilled in the art may apply other kinds of virtualization technologies and network technologies and etc. to make various modifications and changes to the disclosure. Any modifications, equivalent replacements, improvements and the like made within the spirit and principle of the disclosure shall be included in the protection scope of the disclosure.

What is claimed is:

1. A home gateway and smart terminal integrated system, comprising a home gateway body and at least one subsidiary smart terminal, wherein
the subsidiary smart terminal comprises a terminal hardware layer and a terminal software layer, and is configured to display a user graphic interface and support a user input operation; and
the home gateway body comprises a hardware layer and a software layer and is configured to perform software and hardware resource processing on the user graphic interface and the user input operation, and to send a processing result to the subsidiary smart terminal or an external network, or to receive data from outside and make a response.

2. The home gateway and smart terminal integrated system according to claim 1, wherein the hardware layer comprises a multi-core processor, a Random Access Memory (RAM), a solid state driver, a Universal Serial Bus (USB) host, an Ethernet switch module, a Wireless Fidelity (WiFi) access module, and an external network interface module.

3. The home gateway and smart terminal integrated system according to claim 2, wherein the software layer comprises a Virtual Machine Monitor (VMM) module, a Virtual Machine (VM) and a home gateway software module, wherein
the VMM module is configured to establish at least one said VM, and distribute and schedule a hardware resource for the VM;
the VM comprises a subsidiary smart terminal operating system and applications; the subsidiary smart terminal operating system is configured to draw the user graphic interface and respond to the user input operation, and is further configured to complete data communication outside; and
the home gateway software module is configured to operate a built-in software function of an existing home gateway.

4. The home gateway and smart terminal integrated system according to claim 3, wherein the VMM module comprises a switcher software module, a first driver proxy, an Ethernet driver driver, a WiFi driver, and an external network driver, wherein
the switcher software module is configured to inquire for a Media Access Control (MAC) address, and write, according to the MAC address, data into a driver queue;
the Ethernet driver is provided with an Ethernet driver queue, and is configured to drive, when the integrated system performs wired communication with a home network, the integrated system to write data into the Ethernet driver queue;
the WiFi driver is provided with a WiFi driver queue and is configured to drive, when the integrated system performs wireless communication with a home network, the integrated system to write data into the WiFi driver queue; and
the external network driver is provided with an external network driver queue and is configured to drive, when the integrated system performs data communication with an external network, the integrated system to write data into the external network driver queue.

5. The home gateway and smart terminal integrated system according to claim 4, wherein the terminal software layer comprises a second driver proxy.

6. The home gateway and smart terminal integrated system according to claim 4, wherein the first driver proxy comprises a Gateway Display Driver Proxy (GDDP) and an input driver proxy; the second driver proxy comprises a terminal display driver proxy and a touch driver proxy, wherein
the GDDP and the terminal display driver proxy are configured to display the user graphic interface, and establish a link during initialization of the integrated system;
the input driver proxy and the touch driver proxy are configured to support the user input operation, and establish a link during initialization of the integrated system.

7. The home gateway and smart terminal integrated system according to claim 6, wherein the GDDP is further configured to store data.

8. A communication method for a home gateway and smart terminal integrated system, comprising:
displaying, by a subsidiary smart terminal, a user graphic interface and supporting a user input operation;
encapsulating, by a home gateway body, data corresponding to the user graphic interface and the user input operation to form a data frame, and then sending, according to a Media Access Control (MAC) address, the data frame to a subsidiary smart terminal which is connected to a home network, or to an external network, or receiving data from an external network and making a response.

9. The communication method for a home gateway and smart terminal integrated system according to claim 8, wherein the communication method comprises data communication between an operating system of the subsidiary smart terminal and the home network, data communication between the operating system of the subsidiary smart terminal and the external network, and data communication between operating systems of subsidiary smart terminals, wherein
when the data communication is performed between the operating system of the subsidiary smart terminal and the home network, a driver module first encapsulates data to form a data frame, a Virtual Machine Monitor (VMM) module then captures the data frame and delivers the data frame to a switcher software module; the switcher software module performs data transmission according to a target MAC address;
when the data communication is performed between the operating system of the subsidiary smart terminal and the external network, the driver module first encapsulates data to form a data frame, the VMM module then captures the data frame and delivers the data frame to the switcher software module; after the data frame is sent to a home gateway software module to process, the switcher software module performs data transmission according to a target MAC address;
when the data communication is performed between the operating systems of the subsidiary smart terminals, after the driver module encapsulates data to form a data frame, the switcher software module forwards the data frame directly.

10. The communication method for a home gateway and smart terminal integrated system according to claim 9, wherein the driver module comprises an Ethernet driver, a Wireless Fidelity (WiFi) driver, an external network driver and a network driver module.

11. The home gateway and smart terminal integrated system according to claim 5, wherein the first driver proxy comprises a Gateway Display Driver Proxy (GDDP) and an input driver proxy; the second driver proxy comprises a terminal display driver proxy and a touch driver proxy, wherein
the GDDP and the terminal display driver proxy are configured to display the user graphic interface, and establish a link during initialization of the integrated system;
the input driver proxy and the touch driver proxy are configured to support the user input operation, and establish a link during initialization of the integrated system.

12. The home gateway and smart terminal integrated system according to claim 11, wherein the GDDP is further configured to store data.
